(19) United States
(12) Patent Application Publication
(10) Pub. No.: US 2006/0146040 A1
(43) Pub. Date: Jul. 6, 2006

(54) Trick play using crt scan modes

(75) Inventor: Richard Chi-Te Shen, Morgan Hill, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/560,713

(22) PCT Filed: Jun. 29, 2004
(86) PCT No.: PCT/IB04/51051

§ 371 Date: Dec. 15, 2005

Related U.S. Application Data
(60) Provisional application No. 60/483,791, filed on Jun. 30, 2003.

(51) Int. Cl. G09G 5/00

(52) U.S. Cl. 345/204

(57) ABSTRACT

Video frames of a performance are provided at times at a slower input rate and at other times at a faster input rate. A video display is automatically switched to a first display scan mode when receiving frames at the slower input rate, and switched to a second display scan mode when receiving frames at the faster input rate. The second display scan mode being different than the first display scan mode. For example, the display scan modes may have different frame rates or the first display mode may be progressive and the second display scan mode may be interlaced.

The invention relates to the field of video display with trick play modes.

Recently CRT monitors with multiple scan modes have become more popular. Usually there are at least two scan modes. In the Americas, one scan mode has a 60 Hz scan rate for displaying 30 frames per second (60 interlaced fields), and the other mode has a 120 Hz scan rate for displaying 60 frames per second (120 interlaced fields). In most of the rest of the world the scan rates are 50 Hz and 100 Hz. The scan mode can usually be selected using buttons on the front of the monitor or by accessing a menu. Often, when operated in the mode with the 60 Hz scan rate and interlaced frames, there is some barely detectable flicker especially in a room that is brightly lit with fluorescent lighting. On the other hand, when operated in the mode with an 120 Hz scan rate, there may be distortions in brightness, contrast, or color because of the difficulty in aiming the electron gun of the CRT at such high scan rates. For this reason, monitors having duel 60/120 modes are often operated at the 60 Hz mode rather then the faster mode.

For computing tasks 60 and 120 Hz frame display rates are convenient because computer hardware usually supports providing display frames at these rates. However for video display, the frames are not necessarily at these rates.

The MPEG video standard specifies several standard frame rates for normal real-time display and includes a frame rate code that indicates the frame rate for normal real-time display. For movies the frame rate is 24 per second, and for American television the frame rate is usually 30 per second (25 in most of the rest of the world). If a display device such as a CRT has a display rate that is higher than the MPEG frame rate, then the decoder can simply drop some frames. More commonly, if the MPEG frame rate is a lower rate then the frame rate of the display, then frames can be repeated or additional frames can be derived by averaging between sequential frames.

Video sources such as VCR drives and DVD drives usually also provide for trick play speeds. Common trick play speeds include forward and reverse play at various multiples of the normal play speed such as ½×, 2×, 4×, 8× and 16×. These trick play modes are often provided using the same frame display rate and just dropping some of the frames or repeating some of the frames. For example, for 4× play, only every fourth frame is displayed so that three frames are dropped between each two successive frames that are shown.

Those skilled in the art are directed to U.S. application Ser. No. 09/281013 filed Mar. 30, 1999 (WO 00/59219 published Oct. 5, 2000) and WO 00/57241 published Sep. 28, 2000 which describe trick mode implementations on display devices. Also, those skilled in the art are directed to U.S. application Ser. No. 10/185,905 filed Jun. 28, 2002 describing conversion of video formats to 120 Hz 4× interlaced format. These citations are hereby incorporated herein in whole by reference.

In the invention herein, a display device is provided which has multiple fixed predetermined display scan modes with corresponding frame display rates that are independent of the average frame input rate and selectable at least between: a first mode and a second mode that is substantially different than the first display rate. Video frames of a video program are provided with a predetermined standard average input rate that is selectable at least between: a slower average input rate and a faster average input rate that is substantially different than the slower input rate. The display scan mode of the display is selected so as to select the first mode when receiving frames at the faster input rate and to select the second mode when receiving frames at the slower input rate.

The first display scan mode may have a higher frame rate, the advantage of this is that fast trick play modes have a less jerky appearance, when fewer frames are dropped. The first mode may be a progressive display scan mode and the second mode may be an interlaced display scan mode and the display device may have a converter for converting progressive frames at a fast rate to interlaced frames at a lower frame rate.

Additional aspects and advantages of the invention will become readily apparent to those skilled in the art from the detailed description below with reference to the following drawings.

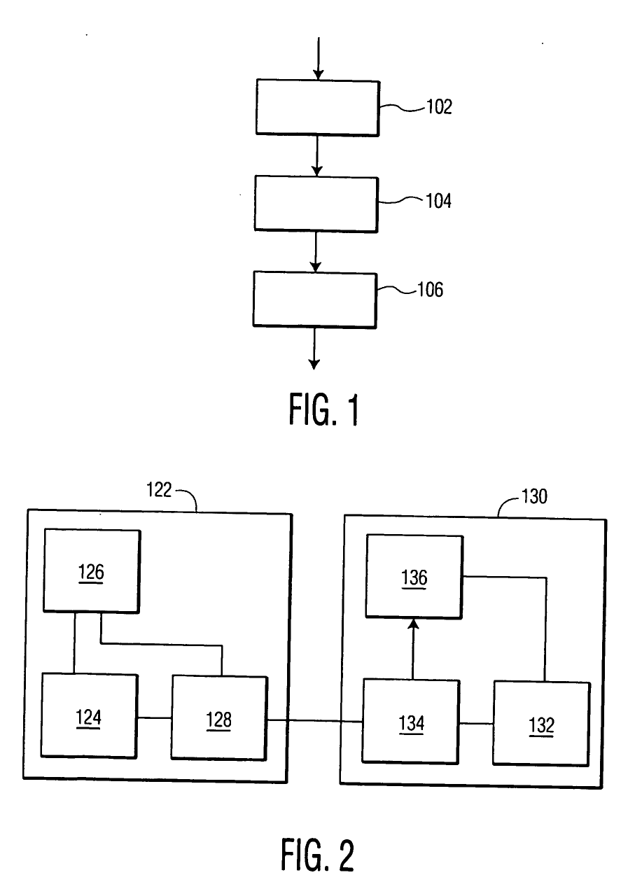

FIG. 1 illustrates the method of the invention for automatically providing correspondence between the scan mode of a display device and the input frame rate.

FIG. 2 illustrates an example video system of the invention for automatically providing correspondence between a input frame rate and the display scan mode.

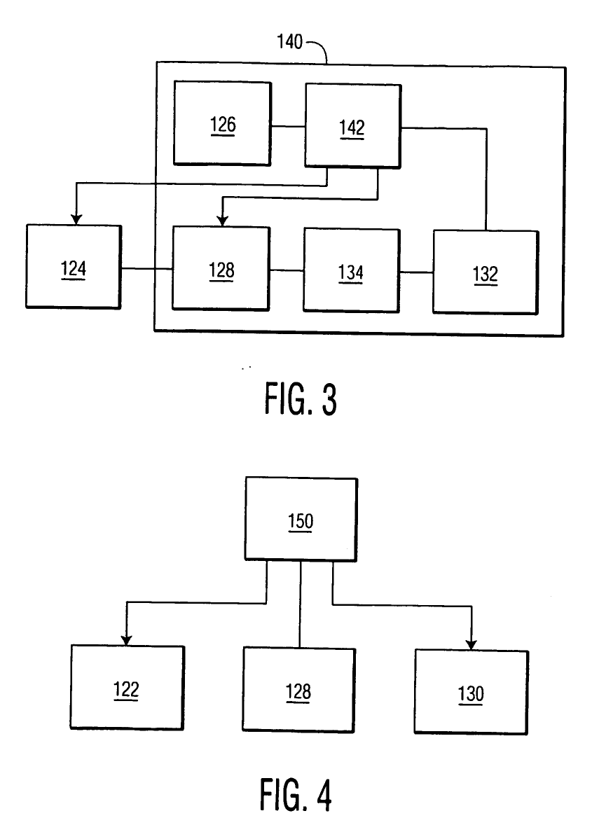

FIG. 3 illustrates an alternative example video system of the invention for automatically providing correspondence between an input frame rate and the display scan mode.

FIG. 4 illustrates yet another example video system of the invention for automatically providing correspondence between a input frame rate and the display rate mode of a display device for trick mode play.

In the following descriptions of the drawings, the same labels in different figures indicate similar devices. For convenience, such devices will only be described in detail in relation to the earliest described figure in which they appear.

FIG. 1 is a flow chart showing a specific example of the method 100 of the invention for automatically providing correspondence between a input frame rate and the display rate mode of a display device for trick mode play. In step 102 a display device is provided that has multiple fixed predetermined display scan modes with corresponding frame display rates that are independent of the average frame input rate and selectable at least between: a first scan mode and a second scan mode that is substantially different than the first scan mode.

Most pixilated displays have a pixel refresh rate that defines a frame display rate. Typically those frame display rates are predetermined fixed, hardware dependent rates. Those skilled in the art could modify any such devices to provide multiple different frame display rates that could be automatically selected. In addition, common existing multi-mode display device include multi-mode CRTs, LCDs, plasma displays and LCOS projectors. The display scan modes of those devices are commonly manually selected, but those skilled in the art could modify such devices for automatic selection of mode depending on an indication of the rate at which frames are being provided. For example, the display device could automatically detect the frame input rate or the display device could receive a command from the video source indicating a change in the input rate, or the display device could receive a user input command to change the input rate.

In step 104, video frames of a video program are provided. The program has predetermined standard average input rates that are selectable at least between: a slower average input rate and a faster average input rate that is substantially different than the slower input rate.

The video frames could be provided by a video source such as a DVD drive or a digital VCR drive, or a magnetic disc drive (hard drive). A user input device could be provided to select between predetermined average input rates at which the frames could be provide to the display. The user input could be, for example, a keyboard, a remote control, or buttons on the front panel of the video source.

In step 106, the mode of the display device is automatically controlled to select the first mode with a when receiving frames at a faster input rate and to select the second mode when receiving frames at a slower input rate.

The automatic control of the display device may be provided by a detector for determining the input frame rate and a processor for changing the display scan mode depending on the input frame rate. Alternatively, the display device may receive a command from the source of the video frames to change the display scan mode depending on the selected input frame rate. Another possibility is that a user input device may be provided, and the input of a command to select operation at a display scan mode may also control the selection of a input frame rate.

The invention herein can be used in many different ways. The slower frame input rate may constitute a normal play mode and the faster input rate may constitute a fast motion mode. Alternatively, the slower input rate may constitute a slow motion mode and the faster input rate constitute normal real-time play. Also, both input rates may be for different slow motion modes or both input rates may be for different fast motion modes.

For either the slower or faster frame rates, if the frame input rate is slower than the frame display rate then at least some received frames will have to be repeated. Also, for either the slower or faster frame rates, if the frame input rate is higher than the frame display rate then some frames will have to be dropped.

Usually input rates for slow motion trick modes are simply integer divisions of the normal real-time frame input rate (positive integers for forward modes and negative integers for reverse modes). This simplifies the implementation of slow motion, because each frame can be repeated the same number of times. Similarly the input rates for fast motion trick play modes are simply integer multiple of the normal real-time frame input rate. This simplifies the implementation of fast motion trick play because then the same number of frames can be dropped between each frame that is displayed.

It is convenient if the faster input rate is twice as fast as the slower input rate, because for most current multi-mode display devices there are two modes in which one is twice as fast as the other.

To simplify implementation and minimize jerkiness if the slower display rate were equal to the slower input rate, because then, every frame would simply be displayed one time, and there would be no repeated or dropped frames. Similarly, it would simplify implementation and minimize jerkiness if the faster display rate were equal to the faster input rate, because then, every frame would simply be displayed one time, and there would be no repeated or dropped frames.

For example, the input frames in both the slower and faster input rate may be provided in a progressive scan format with he first display scan mode at a 25 Hz or 30 Hz progressive scan mode and the second display scan mode at 50 Hz or 60 Hz progressive scan mode.

Alternatively, the input frames in both the slower and faster input rate may be in a 2× interlaced scan format with the first display scan mode, a 50 Hz or 60 Hz 2× interlaced scan mode, and the second display scan mode, a 100 Hz or 120 Hz 2× interlaced scan mode.

FIG. 2 illustrates an example embodiment of a video system 120 of the invention in which the mode of a display device is automatically corresponds to the average input frame rate provided by the video program source. In this example of a specific embodiment, in video program source 122, the average frame rate of a medium drive 124 is selected using user input device 126.

The medium drive may be an optical medium drive such as a DVD drive or a video CD drive or it may be a digital VCR tape drive, or a magnetic hard disc drive containing a video program. The medium drive is capable of providing video frames at a normal real-time play rate for the program or at trick play rates that are slower or faster than the normal play rate.

The user input may be buttons on the front panel of the video medium drive or a remote control capable of communicating with the video medium drive, or the user input may be a computer keyboard that communicates with the video medium drive through a personal computer and/or home network.

The video program source 122 provide frames to a display device 130. The display device includes a multi-mode display 132 that receives the frames through buffer 134. A processor 136 detects the input frame rate of the buffer 134, and automatically selects the display scan mode of the multi-mode display depending on the input frame rate.

The multi-mode display may be a CRT which is capable, for example, of displaying frames at a rate of either 30 frames or 60 frames per second. Alternatively the muti-mode display may be an LCD screen, a plasma display screen, or a display projector.

The display device displays frames at a faster rate when frames are received at a fast average rate, and the display device displays frames at a slower rate when frames are received at a slower average rate. For example, an MPEG movie may have a normal play input rate of 24 frames per second and in response to this frame rate the display will display frames at the rate of 30 frames per second. In order to display more frames than are received, the display device will occasionally display some of the frames twice. Buffer 134 stores the frames so that they can be displayed multiple times for slow trick play modes. When the video program source goes into a fast motion trick mode such as 4 times normal speed (called 4×) (60 frames per second), then the display device will detect the faster frame rate and switch the operating mode to 60 frames per second. The display device will have to occasionally drop some of the video frames, but will not ever have to drop two frames in a row. For programs with normal display rates of 24 or 30 frames per second, Display of 4× speed on a display operating at 60 frames per second appears smooth, whereas even 2× speed appears jerky on a display operating at 30 frames per second.

Alternatively, when the user inputs a command through user input 126, to initiate a fast motion trick play mode, then video medium drive 124 provides a command to the display device to automatically switch the display device to operate in a mode for displaying frames at a faster rate. Processor 136 receives the command and selects a faster rate mode for the multi-mode display 132. In this case there is no need for processor 136 to detect the input frame rate.

converter 128 converts the input frames as required for the display device. For a slow motion trick play mode the converter may repeat frames or for a fast motion trick play mode the converter may drop frames or combine frames so as to provide the frame rate required for the display device scan mode. The converter may convert frames formatted for progressive scan to frames formatted for interlaced scans, for example, to reduce the frame rate. The conversion of the converter is also controlled by the user input command.

For example, multiple frames with a progressive scan format may be combined by combining some of the lines of each frame together to form a combined frame with a progressive scan format. Thus n frames may be combined using every n th line of each of the n frames to form the combined frame, every n th line beginning at a different line for each different frame. For example, a pair of frames are combined by combining the odd lines of one frame with the even lines of the other frame.

In another example, multiple frames with a progressive scan format may be combined by dropping lines of each frame to form a combined frame with an interlaced format. Thus, n frames may be combined by dropping all the lines except every n th line of each frame, every n th line beginning at a different line position in each different frame of the n frames.

In yet another example, multiple frames with an interlaced format may be combined by dropping one or more fields of each frame to form a combined frame with an interlaced format. For example a different field from each frame can be combined to form the combined frame.

In yet another example, multiple frames with an interlaced scan format may be combined by dropping lines of each frame to form a combined frame of interlaced format. Thus, n frames can be combined by dropping all the lines except every n th line of each field, every n th line beginning at a different line position in each different frame of the n frames.

In FIG. 3, Display device 142 includes processor 142 communicating with user input 126. When a user inputs a command through user input 126 to select a fast motion trick play mode, then processor 142 automatically selects a display scan mode with a higher frame display rate and the processor sends a signal to video program source 124 to automatically provide frames at a faster frame rate. In this case converter 128 is provided as part of the display device.

In FIG. 4, user input device 150, communicates directly with both the video program source 122, converter 128, and the display device 130. When the user inputs a command to operate the system in a fast motion trick play mode, then the same command automatically causes the video program source 122 to provide frames at a higher input rate and the display device 130 to switch to a higher display rate.

The invention has been described above in relation to specific example embodiments. Those skilled in the art will know how to modify these example embodiments within the scope of the invention herein. The invention is only limited by the following claims.

We claim:

1. A method comprising:
at times providing video frames of a performance at a slower input rate;
at other times providing video frames of the performance at a faster input rate;
switching a video display to display frames in first display scan mode when receiving frames at the slower input rate; and
switching the video display to display frames in a second display scan mode when receiving frames at the faster input rate, the second display scan mode being different than the first display scan mode.

2. The method of claim 1, wherein: the slower input rate is equal to a normal play rate of the video performance, and the faster play rate is for a fast motion trick mode.

3. The method of claim 1 wherein the frames received in both the slower and faster input rate are in a progressive scan format; the first display scan mode is a 25 Hz or 30 Hz progressive scan mode; and the second display scan mode is a 50 Hz or 60 Hz progressive scan mode.

4. The method of claim 1 wherein: the frames received in both the slower and faster input rate are in a 2× interlaced scan format; the first display scan mode is a 50 Hz or 60 Hz 2× interlaced scan mode; and the second display scan mode is a 100 Hz or 120 Hz 2× interlaced scan mode.

5. The method of claim 1 further comprising repeating the display of frames received at the slower input rate to provide a required frame rate for the first display scan mode.

6. The method of claim 1 further comprising dropping some of the frames received at the higher input rate to provide a required frame rate for the second display scan mode.

7. The method of claim 1 further comprising combining frames received at a faster input rate into combined frames to provide a required frame rate for the second display scan mode.

8. The method of claim 1, wherein:
the method further comprises detecting the input rate; and
automatically selecting the display scan mode depending on the detected input rate.

9. The method of claim 1, wherein:
the method further comprises receiving a user input command to change the input rate; and
changing the input rate in response to the user input command to change the input rate.

10. The method of claim 1, wherein:
the method further comprises receiving a user input command to change the input rate; and
changing the display scan mode in response to the user input command to change the input rate.

11. The method of claim 1, wherein the received frames are provided by a medium player that provides video frames at a controllable average input rate.

12. The method of claim 11, wherein the medium player is selected from a DVD drive, a digital VCR, and a magnetic disc drive.

13. The method of claim 11, wherein the medium player includes user input apparatus for providing a command to change the average input rate.

14. The method of claim 1, wherein the display is a CRT and the different display scan modes are selected from: a progressive scan 30 Hz mode, a progressive scan 60 Hz mode, a 2× interlaced 60 Hz mode, a 2× interlaced 120 Hz mode, a 4× interlaced 120 Hz mode and a 4× interlaced 240 Hz mode.

15. The method of claim 1, wherein:
the display is a CRT and the different display scan modes are selected from: a progressive scan 25 Hz mode, a progressive scan 50 Hz mode, a 2× interlaced 50 Hz mode, a 2× interlaced 100 Hz mode, a 4× interlaced 100 Hz mode and a 4× interlaced 200 Hz mode.

16. A method comprising:
at times providing video frames at a slower input rate;
displaying the frames received at the slower input rate;
at other times providing video frames at a higher input rate;
combining the frames received at the higher input rate into combined frames at the slower frame rate; and
displaying the combined frames at the slower frame rate.

17. The method of claim 16 wherein multiple frames with a progressive scan format are combined by combining some of the lines of each frame together to form a combined frame with a progressive scan format.

18. The method of claim 17 wherein n frames are combined using every n th line of each of the n frames to form the combined frame, every n th line beginning at a different line for each different frame.

19. The method of claim 18 wherein a pair of frames are combined by combining the odd lines of one frame with the even lines of the other frame.

20. The method of claim 16 wherein multiple frames with a progressive scan format are combined by dropping lines of each frame to form a combined frame with an interlaced format.

21. The method of claim 20 wherein n frames are combined by dropping all the lines except every n th line of each frame, every n th line beginning at a different line position in each different frame of the n frames.

22. The method of claim 16 wherein multiple frames with an interlaced format are combined by dropping one or more fields of each frame to form a combined frame with an interlaced format.

23. The method of claim 22 wherein a different field from each frame is combined to form the combined frame.

24. The method of claim 16 wherein multiple frames with an interlaced scan format are combined by dropping lines of each frame to form a combined frame of interlaced format.

25. The method of claim 24 wherein n frames are combined by dropping all the lines except every n th line of each field, every n th line beginning at a different line position in each different frame of the n frames.

26. The method of claim 16 wherein the slower input rate has the same frame rate as the slower frame rate.

27. A video player comprising:
a display device (132) having multiple fixed predetermined display scan modes with corresponding display rates that are independent of the average frame input rate and selectable at least between: a first display scan mode and a second display scan mode that is substantially different than the first display scan mode;
an input (122) for video frames of a video program with an predetermined standard average input rate that is selectable at least between: a slower average input rate and a faster average input rate that is substantially different than the slower input rate; and
means (136) for selecting the first display scan mode when receiving frames at the slower input rate and for selecting the second display scan mode when receiving frames at the faster input rate.

28. The video player of claim 18, wherein the slower input rate is equal to a normal play rate of the video performance, and the faster play rate is for a fast motion trick mode.

29. The video player of claim 18, wherein: the frames received in both the slower and faster input rate are in a progressive scan format; the first display scan mode is a 25 Hz or 30 Hz progressive scan mode; and the second display scan mode is a 50 Hz or 60 Hz progressive scan mode.

30. The video player of claim 18, wherein: the frames received in both the slower and faster input rate are in a 2× interlaced scan format; the first display scan mode is a 50 Hz or 60 Hz 2× interlaced scan mode; and the second display scan mode is a 100 Hz or 120 Hz 2× interlaced scan mode.

31. The video player of claim 18, wherein the received video player further comprises means (128) for converting the video frames including repeating the display of frames received at the slower input rate to provide a required frame rate for the first display scan mode.

32. The video player of claim 18, wherein the video player further comprises means (128) for converting the received video frames including dropping some of the frames received at the higher input rate to provide a required frame rate for the second display scan mode.

33. The video player of claim 18, wherein the video player further comprises means for converting the received video frames including combining frames received at a faster input rate into combined frames to provide a required frame rate for the second display scan mode.

34. The video player of claim 18, wherein the video player further comprises means (136) for detecting the input rate; and the selecting means selects the display scan mode depending on the detected input rate.

35. The video player of claim 18, wherein:
the video player further comprises a user input (126, 150) for providing a command to change the input rate; and
means (142) for changing the input rate in response to the user input command to change the input rate.

36. The video player of claim 18, wherein:
the video player further comprises a user input (126) for providing a command to change the input rate; and
means (142) for changing the display scan mode in response to the user input command to change the input rate.

37. The video player of claim 29, wherein the video player further comprises a video medium reader (124) for providing the video frames of a video program with a controllable average input rate.

38. The video player of claim 30, wherein the video medium reader player is selected from a DVD drive, a digital VCR, and a magnetic disc drive.

39. The video player of claim 30, wherein the video medium player includes a user input for providing a command to change the average input rate.

40. A display device comprising:
a video display for displaying video frames at one of a multitude of different predetermined display scan rates;
a user input device for selecting a frame rate and a corresponding display scan mode of the video device from among multiple different predetermined display scan modes, the video frame display rate of the display device depending on the display scan mode; and
a transmitter to transmit the selected frame rate to a video source to provide frames at an average rate depending on the selection.
